(19) United States
(12) Patent Application Publication
(10) Pub. No.: US 2002/0015191 A1
(43) Pub. Date: Feb. 7, 2002

(54) Image sensor and method of driving the same

(75) Inventor: Yoshinori Muramatsu, Tokyo (JP)

Correspondence Address: Patent Group, Hutchins, Wheeler & Dittmar, 101 Federal Street, Boston, MA, 02110, US

(73) Assignee: NEC Corporation

(21) Appl. No.: 09/730,313

(22) Filed: Dec. 5, 2000

(30) Foreign Application Priority Data
Dec. 8, 1999 (JP) 349180/1999

(51) Int. Cl. H04N 1/04

(52) U.S. Cl. 358/474; 358/494

(57) ABSTRACT

An image sensor includes (a) a pixel array, (b) a horizontal shift register horizontally scanning the pixel array, (c) a vertical shift register vertically scanning the pixel array to cooperate with the horizontal shift register for selecting a pixel among the pixel array, and (d) a horizontal blanking counter counting a horizontal blanking period and comprised of a shift register.

### BACKGROUND OF THE INVENTION

1. Field of the Invention

The invention relates to an image sensor and a method of driving the same.

2. Description of the Related Art

Many image sensors have been suggested so far. Among image sensors, a MOS image sensor and a CCD image sensor are typical ones.

Whereas a CCD image sensor is fabricated in accordance with a process having been developed only for a CCD image sensor, a MOS image sensor can be fabricated in accordance with a standard process for fabricating MOS. In addition, a MOS image sensor operates at a relatively low voltage and by a single power source, ensuring small power consumption. Furthermore, a peripheral logic and macro can be fabricated in a single chip. Hence, a MOS image sensor has attracted attention because of those advantage.

FIG. 1 is a block diagram of a conventional MOS image sensor.

The illustrated MOS image sensor 10 is comprised of a pixel array 1, a vertical shift register 2 vertically scanning the pixel array 1, a horizontal shift register 3 horizontally scanning the pixel array 1, a first clock generator 4 providing clock signals to the vertical shift register 2 to drive the vertical shift register 2, a second clock generator 5 providing clock signals to the horizontal shift register 3 to drive the horizontal shift register 3, and a controller 6 receiving an external trigger signal and transmitting the external trigger signal to both the first and second clock generators 4 and 5.

In operation of the MOS image sensor 10, the vertical shift register 2 selects a horizontal address line one by one among a plurality of horizontal address lines vertically arranged in the pixel array 1, in accordance with a clock signal transmitted from the first clock generator 4. At the same time, the horizontal shift register 3 selects a vertical signal line one by one along the thus selected horizontal address line among a plurality of vertical signal lines horizontally arranged in the pixel array 1, in accordance with a clock signal transmitted from the second clock generator 5. As a result, electric charges are successively read out of a cell having a designated address.

In the above-mentioned conventional MOS image sensor 10, the vertical and horizontal registers 2 and 3 are designed to receive timing signals necessary for operation thereof, through the controller and further through the first and second clock generators 4 and 5.

As a result, the conventional MOS image sensor 10 is accompanied with a problem that the vertical and horizontal shift registers 2 and 3 have to receive timing signals which are produced externally of the MOS image sensor 10, resulting in that the MOS image sensor 10 has to receive a further external signal, and that there are generated much noises.

FIG. 2 is a block diagram of another conventional MOS image sensor. The illustrated MOS image sensor 10A is comprised of a pixel array 1, a vertical shift register 2 vertically scanning the pixel array 1, a horizontal shift register 3 horizontally scanning the pixel array 1, a first clock generator 4 providing clock signals to the vertical shift register 2 to drive the vertical shift register 2, a second clock generator 5 providing clock signals to the horizontal shift register 3 to drive the horizontal shift register 3, a first counter 7 which counts a period in which charges are vertically read out, a second counter 8 which counts a period in which charges are horizontally read out, a third counter 9 which counts a horizontal blanking period, and a controller 6 receiving an external trigger signal and transmitting the external trigger signal to the third counter 9.

The first to third counters 7 to 9 are all comprised of a binary counter.

However, the conventional MOS image sensor illustrated in FIG. 2 is accompanied with problems that diving noise in a main clock signal, caused by the binary counters may be mixed to an analog signal, and that a plurality of binary counters have to be arranged apart from the shift registers with the result of an increase in both a size and complexity of the image sensor.

Japanese Unexamined Patent Publication No. 6-78218 has suggested an image sensor including means for transmitting a plurality of video signals from each of pixels where the vide signals have different accumulation times from one another, and means for transmitting a signal indicated of a difference among the video signals. However, a problem of a complexity in a structure of the image sensor remains unsolved.

Japanese Unexamined Patent Publication No. 10-93069 has suggested a MOS image sensor including a n-type transistor and a p-type transistor connected in parallel with each other between a vertical signal line and a horizontal signal line. Gates of the n- and p-type transistors are controlled by a horizontal shift register, when signals are successively transmitted through the vertical signal line and then through the horizontal signal line. However, this MOS image sensor is accompanied with a problem that since a lot of transistors are used in the image sensor, it is unavoidable for the image sensor to be complicated in a structure.

### SUMMARY OF THE INVENTION

In view of the above-mentioned problems in the conventional image sensors, it is an object of the present invention to provide a MOS image sensor which is capable of operating without generation of dividing noises, and further without receipt of external control signals.

In one aspect of the present invention, there is provided an image sensor including (a) a pixel array, (b) a horizontal shift register horizontally scanning the pixel array, (c) a vertical shift register vertically scanning the pixel array to cooperate with the horizontal shift register for selecting a pixel among the pixel array, and (d) a horizontal blanking counter counting a horizontal blanking period.

It is preferable that the horizontal blanking counter is comprised of a shift register.

It is preferable that the image sensor further includes a controller receiving an external trigger signal and transmitting the external trigger signal to the horizontal blanking counter, the horizontal blanking counter starting counting the horizontal blanking period on receipt of the external trigger signal.

It is preferable that the vertical shift register is activated in synchronization with activation of the horizontal blanking counter.

It is preferable that a first flag indicating that horizontal blanking is completed is formed in synchronization with the horizontal blanking counter counting up.

It is preferable that the horizontal shift register is activated when the first flag is formed.

It is preferable that a second flag indicating that horizontal scanning is completed is formed in synchronization with the horizontal shift register counting up.

It is preferable that the horizontal blanking counter is activated when the second flag is formed.

It is preferable that the vertical blanking counter is activated when the second flag is formed.

It is preferable that the image sensor further includes a first clock generator which transmits a first clock signal to the vertical shift register, and a second clock generator which transmits a second clock signal to the horizontal shift register.

It is preferable that the horizontal blanking counter transmits a first timing signal necessary for operating the pixel array, to the horizontal and vertical shift registers, the horizontal and vertical shift registers transmitting and receiving a second timing signal to and from each other, based on the first timing signal.

There is further provided an image sensor including (a) a pixel array, (b) a horizontal shift register horizontally scanning the pixel array, (c) a vertical shift register vertically scanning the pixel array to cooperate with the horizontal shift register for selecting a pixel among the pixel array, (d) a horizontal blanking counter counting a horizontal blanking period, the horizontal blanking counter transmitting a first timing signal necessary for operating the pixel array, to the horizontal and vertical shift registers, the horizontal and vertical shift registers transmitting and receiving a second timing signal to and from each other, based on the first timing signal, and (e) a switch which turns off a power source providing a power to a data line connected to a pixel in the pixel array, while a light is exposed to the pixel array.

In another aspect of the present invention, there is provided a method of driving an image sensor including (a) a pixel array, (b) a horizontal shift register horizontally scanning the pixel array, (c) a vertical shift register vertically scanning the pixel array to cooperate with the horizontal shift register for selecting a pixel among the pixel array, and (d) a horizontal blanking counter counting a horizontal blanking period, the method including the steps of (a) the horizontal blanking counter transmitting a first timing signal necessary for operating the pixel array, to the horizontal and vertical shift registers, and (b) the horizontal and vertical shift registers transmitting and receiving a second timing signal to and from each other, based on the first timing signal.

It is preferable that the method further includes the steps of transmitting an external trigger signal to the horizontal blanking counter, the horizontal blanking counter starting counting the horizontal blanking period on receipt of the external trigger signal.

It is preferable that the method further includes the step of activating the vertical shift register in synchronization with activation of the horizontal blanking counter.

It is preferable that the method further includes the step of forming a first flag indicating that horizontal blanking is completed, in synchronization with the horizontal blanking counter counting up.

It is preferable that the method further includes the step of activating the horizontal shift register when the first flag is formed.

It is preferable that the method further includes the step of forming a second flag indicating that horizontal scanning is completed, in synchronization with the horizontal shift register counting up.

It is preferable that the method further includes the step of activating the horizontal blanking counter when the second flag is formed.

It is preferable that the method further includes the step of activating the vertical blanking counter when the second flag is formed.

It is preferable that the method further includes the step of transmitting a first clock signal to the vertical shift register, and transmitting a second clock signal to the horizontal shift register.

It is preferable that the method further includes the step of turning off a power source providing a power to a data line connected to a pixel in the pixel array, while a light is exposed to the pixel array.

The advantages obtained by the aforementioned present invention will be described hereinbelow.

Whereas a CCD image sensor is fabricated in accordance with a process having been developed only for a CCD image sensor, the MOS image sensor in accordance with the present invention can be fabricated in accordance with a standard process for fabricating MOS. In addition, the MOS image sensor operates at a relatively low voltage and by a single power source, ensuring small power consumption. Furthermore, a peripheral logic and macro can be fabricated in a single chip.

In the present invention, horizontal and vertical scanners and a blanking counter are all comprised of a shift register which ensures that dividing noises to a main clock signal are no longer generated.

In accordance with the present invention, the horizontal and vertical shift registers, which are originally designed to read data out of a pixel array, produce timing signals necessary for operation of the MOS image sensor, and transmit the thus produced timing signals to each other and further to the horizontal blanking counter. This ensures simplification of a structure of the MOS image sensor.

In addition, such timing signals ensure that the MOS image sensor necessarily receives less external control signals.

Furthermore, for instance, when particular operation such as random access or partial access is to be carried out, it would be possible to produce a timing signal to be transmitted from the horizontal and vertical shift registers and the horizontal blanking counter, ensuring simplification in a structure of the MOS image sensor.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a conventional MOS image sensor.

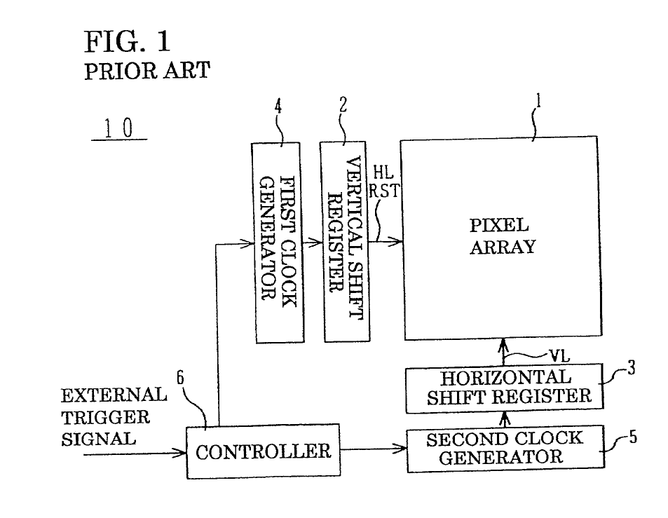

FIG. 2 is a block diagram of another conventional MOS image sensor.

FIG. 3 is a block diagram of a MOS image sensor in accordance with the first embodiment of the present invention.

FIG. 4 is a timing chart showing operation of the MOS image sensor illustrated in FIG. 3.

FIG. 5 is a block diagram of a MOS image sensor in accordance with the second embodiment of the present invention.

### DESCRIPTION OF THE PREFERRED EMBODIMENTS

[First Embodiment]

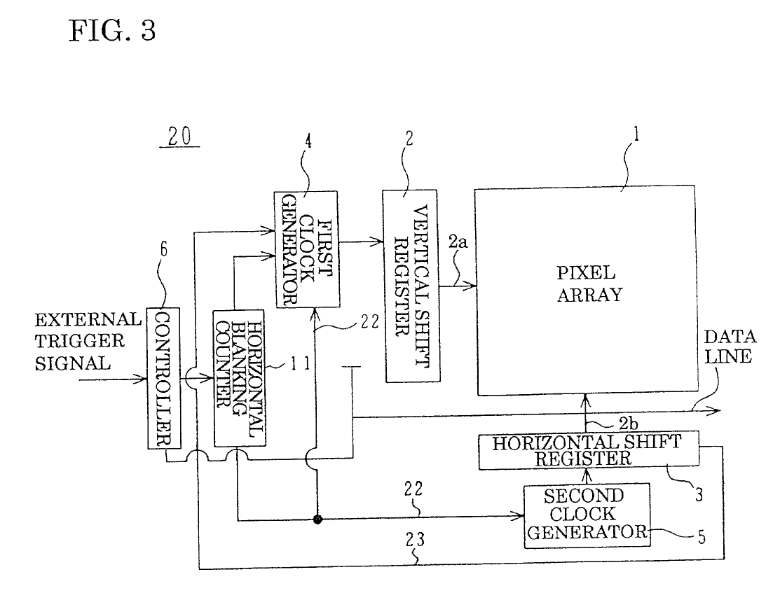

FIG. 3 is a block diagram of a MOS image sensor 20 in accordance with the first embodiment of the present invention.

The MOS image sensor 20 includes a pixel array 1, a horizontal shift register 2 horizontally scanning the pixel array 1, a vertical shift register 3 vertically scanning the pixel array 1 to cooperate with the horizontal shift register 2 for selecting a pixel among the pixel array 1, a vertical clock generator 4 which transmits a first clock signal to the vertical shift register 2, a horizontal clock generator 5 which transmits a second clock signal to the horizontal shift register 3, a horizontal blanking counter 11 counting a horizontal blanking period, and a controller 6 receiving an external trigger signal and transmitting the external trigger signal to the horizontal blanking counter 11.

The vertical shift register 2 transmits a shift signal 2a by which a horizontal read-out line and a reset line in the pixel array 1 are activated line by line. The horizontal shift register 3 transmits a shift signal 2b by which a vertical read-out line in the pixel array 1 is connected to a data line. Thus, a desired pixel is selected by the vertical and horizontal shift registers 2 and 3, and a pixel signal accumulated in the selected pixel is read out.

The vertical and horizontal shift registers 2 and 3 transmit timing signals as well as the shift signals. The vertical shift register 2 transmits a timing signal to the horizontal shift register 3 and vice versa, and resultingly, the MOS image sensor 20 operates.

The horizontal blanking counter 11 in the first embodiment is comprised of a shift register. The horizontal blanking counter 11 is activated, that is, starts counting the horizontal blanking period on receipt of an external trigger signal transmitted from the controller 6.

When the horizontal blanking counter 11 is activated, the horizontal blanking counter 11 transmits a control signal to the vertical shift register 2 through the vertical clock generator 4, resulting in that the vertical shift register 2 is also activated. That is, the vertical shift register 2 is activated in synchronization with activation of the horizontal blanking counter 11.

In addition, the horizontal blanking counter 11 transmits a first flag 22 indicating that horizontal blanking is completed, to the vertical clock generator 4 when the horizontal blanking counter 11 counts up.

When the first flag 22 is transmitted to the vertical clock generator 4, the first flag 22 is transmitted also to the horizontal clock generator 5, resulting in that the horizontal shift register 3 is activated.

When the horizontal shift register 3 counts up, a second flag 23 is transmitted to the vertical shift register 2 through the vertical clock generator 4, and resultingly, the vertical shift register 2 is activated. The second flag 23 indicates that horizontal scanning is completed.

The second flag 23 is transmitted further to the horizontal blanking counter 11. On receipt of the second flag 23, the horizontal blanking counter 11 is activated.

As mentioned above, the horizontal blanking counter 11 transmits the first flag 22 to the vertical and horizontal shift registers 2 and 3 through the vertical and horizontal clock generators 4 and 5, respectively, as a timing signal necessary for operating the pixel array 1. The horizontal shift register 3 transmits the second flag 23 to the vertical shift register 2 through the vertical clock generator 4, based on the first flag 22.

Thus, the first and second flags 22 and 23 as timing signals are transmitted and received among the vertical shift register 2, the horizontal shift register 3, and the horizontal blanking counter 11, and resultingly, the MOS image sensor 20 automatically operates.

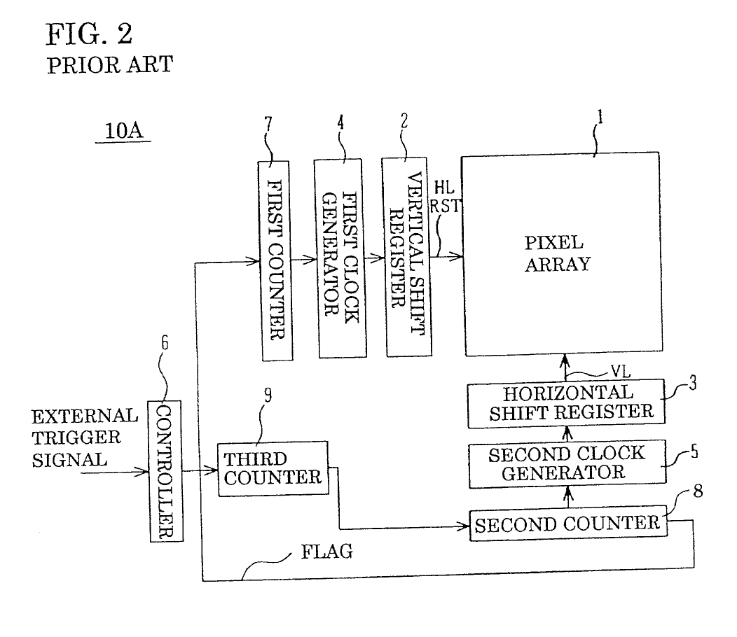

The MOS image sensor 20 in accordance with the first embodiment presents an advantage that dividing noises are not generated in a main clock signal, by having the vertical shift register 2, the horizontal shift register 3 and the horizontal blanking counter 11, without having the first and second counters 7 and 8 (see FIG. 2) both comprised of a binary counter, unlike the conventional MOS image sensor illustrated in FIG. 2.

In addition, the vertical shift register 2, the horizontal shift register 3 and the horizontal blanking counter 11 comprised of a shift register generate the timing signals necessary for operation of the MOS image sensor 20, and transmit the timing signals to one another, ensuring simplification in a structure of the MOS image sensor 20.

Furthermore, the timing signals ensure that the MOS image sensor 20 necessarily receives less external control signals.

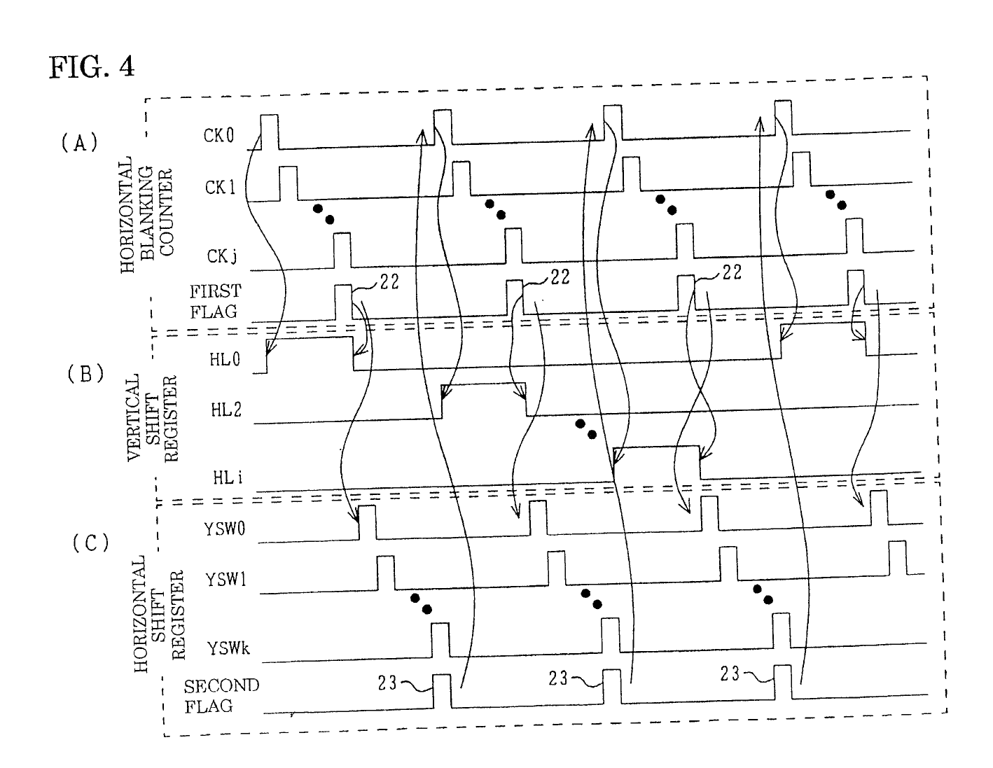

Hereinbelow is explained an operation of the MOS image sensor 20 with reference to FIG. 4.

As illustrated in FIG. 4-(A), the horizontal blanking counter 11 counts horizontal blanking periods from CK0 to CKj on receipt of an external trigger signal through the controller 6.

In a horizontal blanking period, the vertical shift register 2 activates a horizontal read-out line HL0, as illustrated in FIG. 4-(B), and resultingly, a pixel signal accumulated in a 0-th line is read out to a horizontal read-out line.

When the horizontal blanking counter 11 counts CKj, the horizontal blanking counter 11 simultaneously transmits the first flag 22 to the horizontal shift register 3 through the horizontal clock generator 5. On receipt of the first flag 22, the horizontal shift register 3 is activated in turn from YSW0 to YSWk, that is, the horizontal shift register 3 transmits shift signals YSW0 to YSWk, as illustrated in FIG. 4-(C).

As a result, pixel signals having been read out to the vertical read-out lines are read out in turn to data lines in accordance with the shift signals YSW0 to YSWk, and then, externally output.

When the horizontal shift register 3 transmits the shift signal YSW, the horizontal shift register 3 simultaneously transmits the second flag 23 to the horizontal blanking counter 11. On receipt of the second flag 23, the horizontal blanking counter 11 restarts counting horizontal blanking periods.

The second flag 23 is transmitted further to the vertical clock generator 4, and resultingly, the vertical shift register 2 shifts its level from 0 to 1. As a result, a horizontal read-out line HL1 is activated, and hence, a pixel signal accumulated in a first line is read out to a vertical read-out line.

Hereinafter, the same action as mentioned above is repeated.

In the above-mentioned first embodiment, the first and second flags 22 and 23 are transmitted as timing signals among the vertical shift register 2, the horizontal shift register 3 and the horizontal blanking counter 11. For instance, when particular operation such as random access or partial access is to be carried out, it would be possible to produce a timing signal to be transmitted from the horizontal shift register 2, the vertical shift registers 3 and the horizontal blanking counter 11, ensuring simplification in a structure of the MOS image sensor 20.

Though not illustrated in FIG. 3, a horizontal synchronization signal and a vertical synchronization signal are transmitted from conventional means in order to select an address of a pixel in the pixel array 1. In addition, a frame termination signal is transmitted also from conventional means. That is, what is necessary for proper operation of the MOS image sensor 20 is the same as a conventional MOS image sensor unless explicitly mentioned in the specification.

[Second Embodiment]

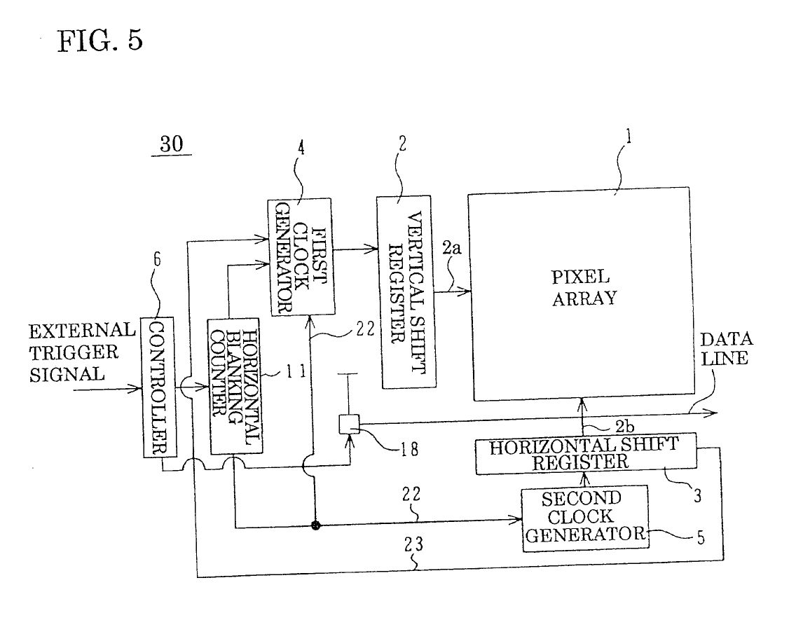

FIG. 5 is a block diagram of a MOS image sensor 30 in accordance with the second embodiment of the present invention.

The MOS image sensor 30 includes a pixel array 1, a horizontal shift register 2 horizontally scanning the pixel array 1, a vertical shift register 3 vertically scanning the pixel array 1 to cooperate with the horizontal shift register 2 for selecting a pixel among the pixel array 1, a vertical clock generator 4 which transmits a first clock signal to the vertical shift register 2, a horizontal clock generator 5 which transmits a second clock signal to the horizontal shift register 3, a horizontal blanking counter 11 counting a horizontal blanking period, a controller 6 receiving an external trigger signal and transmitting the external trigger signal to the horizontal blanking counter 11, and a switch 18 which turns off a power source providing a power to a data line DL connected to a pixel in the pixel array 11, while a light is exposed to the pixel array 11.

In brief, in comparison with the MOS image sensor 20 in accordance with the first embodiment, illustrated in FIG. 3, the MOS image sensor 30 in accordance with the second embodiment is designed to further include the switch 18.

In the MOS image sensor 20 in accordance with the first embodiment, since a timing signal is transmitted from the horizontal shift register 3, the horizontal shift register 3 is activated while the pixel array 1 is exposed to a light, though the horizontal shift register 3 is necessary to be activated only in a period in which a pixel signal is read out. As a result, an electric charge is charged to or discharged from a data line, and hence, a current may run through the data line.

Hence, the MOS image sensor 30 in accordance with the second embodiment is designed to have the switch 18 by which a power source providing a power to a data line is kept turned off, while the pixel array 1 is exposed to a light. Thus, it is possible to reduce current consumption while the pixel array 1 is exposed to a light.

The switch 18 may be driven by a control signal transmitted from the controller 6, for instance.

In a method of driving the MOS image sensor 20, the following steps are carried out.

First, the horizontal blanking counter 11 transmits the first flag 22 as a first timing signal to the vertical and horizontal shift registers 2 and 3 through the vertical and horizontal clock generators 4 and 5. Then, the horizontal shift register 3 transmits the second flag 23 to the horizontal blanking counter 11, and further to the vertical shift register 2 through the vertical clock generator 4, based on the first flag 22.

In a method of driving the MOS image sensor 30, the following additional step as well as the above-mentioned steps is carried out.

A power source providing a power to a data line is kept turned off through the switch 18, while the pixel array 1 is exposed to a light. Thus, it is possible to reduce current consumption while the pixel array 1 is exposed to a light.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 11-349180 filed on Dec. 8, 1999 including specification, claims, drawings and summary is incorporated herein by reference in its entirety.

What is claimed is:

1. An image sensor comprising:
(a) a pixel array;
(b) a horizontal shift register horizontally scanning said pixel array;
(c) a vertical shift register vertically scanning said pixel array to cooperate with said horizontal shift register for selecting a pixel among said pixel array; and
(d) a horizontal blanking counter counting a horizontal blanking period.

2. The image sensor as set forth in claim 1, wherein said horizontal blanking counter is comprised of a shift register.

3. The image sensor as set forth in claim 1, further comprising a controller receiving an external trigger signal and transmitting said external trigger signal to said horizontal blanking counter, said horizontal blanking counter starting counting said horizontal blanking period on receipt of said external trigger signal.

4. The image sensor as set forth in claim 1, wherein said vertical shift register is activated in synchronization with activation of said horizontal blanking counter.

5. The image sensor as set forth in claim 1, wherein a first flag indicating that horizontal blanking is completed is formed in synchronization with said horizontal blanking counter counting up.

6. The image sensor as set forth in claim 5, wherein said horizontal shift register is activated when said first flag is formed.

7. The image sensor as set forth in claim 1, wherein a second flag indicating that horizontal scanning is completed is formed in synchronization with said horizontal shift register counting up.

8. The image sensor as set forth in claim 7, wherein said horizontal blanking counter is activated when said second flag is formed.

9. The image sensor as set forth in claim 7, wherein said vertical blanking counter is activated when said second flag is formed.

10. The image sensor as set forth in claim 1, further comprising a first clock generator which transmits a first clock signal to said vertical shift register, and a second clock generator which transmits a second clock signal to said horizontal shift register.

11. The image sensor as set forth in claim 1, wherein said horizontal blanking counter transmits a first timing signal necessary for operating said pixel array, to said horizontal and vertical shift registers, said horizontal and vertical shift registers transmitting and receiving a second timing signal to and from each other, based on said first timing signal.

12. An image sensor comprising:
(a) a pixel array;
(b) a horizontal shift register horizontally scanning said pixel array;
(c) a vertical shift register vertically scanning said pixel array to cooperate with said horizontal shift register for selecting a pixel among said pixel array;
(d) a horizontal blanking counter counting a horizontal blanking period, said horizontal blanking counter transmitting a first timing signal necessary for operating said pixel array, to said horizontal and vertical shift registers, said horizontal and vertical shift registers transmitting and receiving a second timing signal to and from each other, based on said first timing signal; and
(e) a switch which turns off a power source providing a power to a data line connected to a pixel in said pixel array, while a light is exposed to said pixel array.

13. The image sensor as set forth in claim 12, wherein said horizontal blanking counter is comprised of a shift register.

14. The image sensor as set forth in claim 12, further comprising a controller receiving an external trigger signal and transmitted said external trigger signal to said horizontal blanking counter, said horizontal blanking counter starting counting said horizontal blanking period on receipt of said external trigger signal.

15. The image sensor as set forth in claim 12, wherein said vertical shift register is activated in synchronization with activation of said horizontal blanking counter.

16. The image sensor as set forth in claim 12, wherein a first flag indicating that horizontal blanking is completed is formed in synchronization with said horizontal blanking counter counting up.

17. The image sensor as set forth in claim 16, wherein said horizontal shift register is activated when said first flag is formed.

18. The image sensor as set forth in claim 12, wherein a second flag indicating that horizontal scanning is completed is formed in synchronization with said horizontal shift register counting up.

19. The image sensor as set forth in claim 18, wherein said horizontal blanking counter is activated when said second flag is formed.

20. The image sensor as set forth in claim 18, wherein said vertical blanking counter is activated when said second flag is formed.

21. The image sensor as set forth in claim 12, further comprising a first clock generator which transmits a first clock signal to said vertical shift register, and a second clock generator which transmits a second clock signal to said horizontal shift register.

22. A method of driving an image sensor including (a) a pixel array, (b) a horizontal shift register horizontally scanning said pixel array, (c) a vertical shift register vertically scanning said pixel array to cooperate with said horizontal shift register for selecting a pixel among said pixel array, and (d) a horizontal blanking counter counting a horizontal blanking period,
said method comprising the steps of:
(a) said horizontal blanking counter transmitting a first timing signal necessary for operating said pixel array, to said horizontal and vertical shift registers; and
(b) said horizontal and vertical shift registers transmitting and receiving a second timing signal to and from each other, based on said first timing signal.

23. The method as set forth in claim 22, further comprising the steps of transmitting an external trigger signal to said horizontal blanking counter, said horizontal blanking counter starting counting said horizontal blanking period on receipt of said external trigger signal.

24. The method as set forth in claim 22, further comprising the step of activating said vertical shift register in synchronization with activation of said horizontal blanking counter.

25. The method as set forth in claim 22, further comprising the step of forming a first flag indicating that horizontal blanking is completed, in synchronization with said horizontal blanking counter counting up.

26. The method as set forth in claim 25, further comprising the step of activating said horizontal shift register when said first flag is formed.

27. The method as set forth in claim 22, further comprising the step of forming a second flag indicating that horizontal scanning is completed, in synchronization with said horizontal shift register counting up.

28. The method as set forth in claim 27, further comprising the step of activating said horizontal blanking counter when said second flag is formed.

29. The method as set forth in claim 27, further comprising the step of activating said vertical blanking counter when said second flag is formed.

30. The method as set forth in claim 22, further comprising the step of transmitting a first clock signal to said vertical shift register, and transmitting a second clock signal to said horizontal shift register.

31. The method as set forth in claim 22, further comprising the step of turning off a power source providing a power to a data line connected to a pixel in said pixel array, while a light is exposed to said pixel array.
